(19) United States
(12) Patent Application Publication
(10) Pub. No.: US 2025/0006406 A1
(43) Pub. Date: Jan. 2, 2025

(54) HTS CABLE WITH EDGE COMPONENTS

(71) Applicant: Tokamak Energy Ltd, Abingdon Oxfordshire (GB)

(72) Inventors: Jeroen Van Nugteren, Abingdon Oxfordshire (GB); Robert Slade, Abingdon Oxfordshire (GB)

(21) Appl. No.: 18/709,567

(22) PCT Filed: Nov. 2, 2022
(86) PCT No.: PCT/EP2022/080586

§ 371 Date: May 13, 2024

(30) Foreign Application Priority Data
Nov. 12, 2021 (GB) 2116337.3

(51) Int. Cl. H01B 12/06; H01F 6/06

(52) U.S. Cl. CPC H01B 12/06; H01F 6/06

(57) ABSTRACT

A high temperature superconducting, HTS, cable. The HITS cable comprises a channel, HITS material, and an insulating layer. The channel is formed from conductive material, and has a groove extending along the length of the HTS cable. The HTS material is located within the groove, such that when the HTS material is in a superconducting state the HTS material forms a superconducting current path along the cable, and the HTS material is electrically connected to the channel. The insulating layer is located on a surface of the channel. The channel has a plurality of recesses, each recess containing a electrical assembly comprising a conductive path and/or one or more electrical components, and further containing insulation which separates the electrical assembly from the channel. The HTS cable further comprises, for each recess; a first electrical connection which provides an electrical connection across or through the insulating layer from the electrical assembly within the recess; a second electrical connection which electrically connects the channel to the electrical assembly within the recess; such that any conductive path from the first electrical connection to the second electrical connection through the recess passes through the electrical assembly.

### FIELD OF THE INVENTION

The present invention relates to high temperature superconductors. In particular, the present invention relates to a construction for a cable comprising high temperature superconducting material.

### BACKGROUND

Superconducting materials are typically divided into “high temperature superconductors” (HTS) and “low temperature superconductors” (LTS). LTS materials, such as Nb and NbTi, are metals or metal alloys whose superconductivity can be described by BCS theory. All low temperature superconductors have a self-field critical temperature (the temperature above which the material cannot be superconducting even in zero external magnetic field) below about 30K. The behaviour of HTS material is not described by BCS theory, and such materials may have self-field critical temperatures above about 30K (though it should be noted that it is the physical differences in composition and superconducting operation, rather than the self-field critical temperature, which define HTS and LTS material). The most commonly used HTS are “cuprate superconductors”—ceramics based on cuprates (compounds containing a copper oxide group), such as BSCCO, or ReBCO (where Re is a rare earth element, commonly Y or Gd). Other HTS materials include iron pnictides (e.g. FeAs and FeSe) and magnesium diborate (MgB₂).

ReBCO is typically manufactured as tapes, with a structure as shown in FIG. 1. Such tape 100 is generally approximately 100 microns thick, and includes a substrate 101 (typically an electropolished nickel-molybdenum alloy, e.g Hastelloy™ approximately 50 microns thick), on which is deposited by IBAD, magnetron sputtering, or another suitable technique a series of buffer layers known as the buffer stack 102, of approximate thickness 0.2 microns. An epitaxial ReBCO-HTS layer 103 (deposited by metal oxide chemical vapour deposition (MOCVD) or another suitable technique) overlays the buffer stack, and is typically 1 micron thick. A 1-2 micron silver layer 104 is deposited on the HTS layer by sputtering or another suitable technique, and a copper stabilizer layer 105 is deposited on the tape by electroplating or another suitable technique, which often completely encapsulates the tape. The silver layer 104 and copper stabilizer layer 105 are deposited on the sides of the tape 100 and the substrate 101 too, so that these layers extend continuously around the perimeter of the tape 100, thereby allowing an electrical connection to be made to the ReBCO-HTS layer 103 from either face of the tape 100. These layers 104, 105 may therefore also be referred to as “cladding”. Typically, the silver cladding has a uniform thickness on both the sides and edges of the tape of around 1-2 microns. Providing a silver layer 104 between the HTS layer 103 and the copper layer 105 prevents the HTS material contacting the copper, which might lead to the HTS material becoming poisoned by the copper. The parts of the silver layer 104 and copper stabilizer layer 105 on the sides of the tape 100 are not shown in FIG. 1 for clarity. FIG. 1 also does not show the silver layer 104 extending beneath the substrate 101, as is normally the case. The silver layer 104 makes a low resistivity electrical interface to, and an hermetic protective seal around, the ReBCO layer 103, whilst the copper layer 105 enables external connections to be made to the tape (e.g. permits soldering) and provides a parallel conductive path for electrical stabilisation.

In addition, “exfoliated” HTS tape can be manufactured, which lacks a substrate and buffer stack, but typically has a “surrounding coating” of silver, i.e. layers on both sides and the edges of the HTS layer. Tape which has a substrate will be referred to as “substrated” HTS tape.

An HTS cable comprises one or more HTS tapes, which are connected along their length via conductive material (normally copper). The HTS tapes may be stacked (i.e. arranged such that the HTS layers are parallel), or they may have some other arrangement of tapes, which may vary along the length of the cable. Notable special cases of HTS cables are single HTS tapes, and HTS pairs. HTS pairs comprise a pair of HTS tapes, arranged such that the HTS layers are parallel. Where substrated tape is used, HTS pairs may be type-0 (with the HTS layers facing each other), type-1 (with the HTS layer of one tape facing the substrate of the other), or type-2 (with the substrates facing each other). Cables comprising more than 2 tapes may arrange some or all of the tapes in HTS pairs. Stacked HTS tapes may comprise various arrangements of HTS pairs, most commonly either a stack of type-1 pairs or a stack of type-0 pairs and (or, equivalently, type-2 pairs). HTS cables may comprise a mix of substrated and exfoliated tape.

A superconducting magnet is formed by arranging HTS cables (or individual HTS tapes, which for the purpose of this description can be treated as a single-tape cable) into coils, either by winding the HTS cables or by providing sections of the coil made from HTS cables and joining them together. HTS coils come in three broad classes:
Insulated, having electrically insulating material between the turns (so that current can only flow in the “spiral path” through the HTS cables).
Non-insulated, where the turns are electrically connected radially, as well as along the cables.
Partially insulated, where the turns are connected radially with a controlled resistance, either by the use of materials with a high resistance (e.g. compared to copper), or by providing intermittent insulation between the coils.

Non-insulated coils could also be considered as the low-resistance case of partially insulated coils.

### SUMMARY

According to a first aspect, there is provided a high temperature superconducting, HTS, cable. The HTS cable comprises a channel, HTS material, and an insulating layer. The channel is formed from conductive material, and has a groove extending along the length of the HTS cable. The HTS material is located within the groove, such that when the HTS material is in a superconducting state the HTS material forms a superconducting current path along the cable, and the HTS material is electrically connected to the channel. The insulating layer is located on a surface of the channel. The channel has a plurality of recesses, each recess containing a electrical assembly comprising a conductive path and/or one or more electrical components, and further containing insulation which separates the electrical assembly from the channel. The HTS cable further comprises, for each recess:
a first electrical connection which provides an electrical connection across or through the insulating layer from the electrical assembly within the recess;
a second electrical connection which electrically connects the channel to the electrical assembly within the recess;
such that any conductive path from the first electrical connection to the second electrical connection through the recess passes through the electrical assembly.

According to a second aspect, there is provided a high temperature superconducting cable. The HTS cable comprises a channel, HTS material, an insulating layer, and a conducting layer. The channel is formed from conductive material, and has a groove extending along the length of the HTS cable. The HTS material is located within the groove, such that when the HTS material is in a superconducting state the HTS material forms a superconducting current path along the cable, and the HTS material is electrically connected to the channel. The insulating layer is located on surfaces of the channel other than a surface where the groove is present. The conducting layer is located on an outer surface of the insulating layer, and extending around the insulating layer to make electrical contact with the channel.

According to a third aspect, there is provided a high temperature superconducting, HTS, coil comprising HTS cable wound to form the turns of the coil. The HTS cable comprises a channel, HTS material, and an insulating layer. The channel is formed from conductive material, and has a groove extending along the length of the HTS cable. The HTS material is located within the groove, such that when the HTS material is in a superconducting state the HTS material forms a superconducting current path along the cable, and the HTS material is electrically connected to the channel. The insulating layer is located on a surface of the channel. The channel has a plurality of recesses, each recess containing a electrical assembly comprising a conductive path and/or one or more electrical components, and further containing insulation which separates the electrical assembly from the channel. The HTS cable further comprises, for each recess:
a first electrical connection which provides an electrical connection across or through the insulating layer from the electrical assembly within the recess;
a second electrical connection which electrically connects the channel to the electrical assembly within the recess;

The HTS cable is wound such that the first electrical connections of each turn other than the innermost or outermost turn electrically connects to the channel of an adjacent turn, such that any current path from each turn to the adjacent turn via each recess pass through the electrical assembly within that recess.

The HTS cable of the third aspect may be the HTS cable of the first aspect.

Further embodiments are set out in claim 2 et seq.

### BRIEF DESCRIPTION OF THE DRAWINGS

FIG. 1 is a diagram of an HTS cable;

FIGS. 2A and B show an HTS cable comprising a channel;

FIG. 3A shows an exemplary HTS cable;

FIG. 3B shows current flow between turns of an HTS coil formed from the cable of FIG. 3A;

FIG. 4 shows an alternative construction for a cable equivalent to FIG. 3A;

FIG. 5 shows a further exemplary HTS cable;

FIGS. 6A to 6C show exemplary electronic assemblies for use in cables such as that shown in FIG. 5;

FIG. 7 is a cross section of a yet further exemplary HTS cable;

FIG. 8 shows two possible side views of a cable according to FIG. 7.

### DETAILED DESCRIPTION

FIGS. 2A and B show an HTS cable. FIG. 2A is an isometric view, and FIG. 2B is an end-on cross section. Only a short section of the HTS cable is shown, and it may extend for any length in the directions indicated by the arrows in FIG. 2A. The HTS cable comprises a channel 201. The channel 201 is an elongate conductive element having a groove 202 along its length, e.g. such that it has the u-shaped cross section shown in FIG. 2B. HTS material 203 is placed within the channel, i.e. within the groove. The channel may be formed from any conductive material, e.g. any metal or metal alloy (eg: copper or high copper alloys having greater strength, brass, stainless steel, aluminium, optionally electroplated to assist with soldering), or a conductive composite or ceramic material, or a combination of these such as using different materials in different regions of the channel.

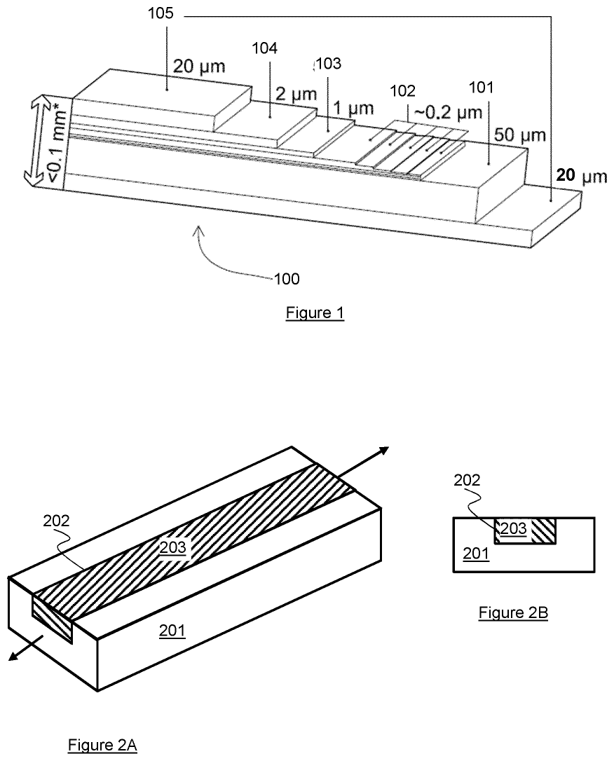

The HTS material may be HTS tapes as described with reference to FIG. 1, which may be arranged as a tape stack or in some more complicated arrangement. To secure the HTS material within the channel, a conductive bonding agent may be used, e.g. solder, a resin impregnated with conductive material, or similar.

The conductive material of the channel provides a low resistance alternative current path for current sharing between the HTS material of the cable, or between cables of a field coil if used in a non- or partially-insulated configuration. Additionally, the channel provides a significant thermal mass in close thermal contact with the HTS, which will help to mitigate any heating caused by HTS material becoming resistive.

The channel may also contain high strength material, such as stainless steel, to provide structural reinforcement to resist the electromagnetic stresses within the coil pack. The channel may also contain high thermal conductivity materials such as copper to compensate for the generally lower thermal conductivity of high strength materials.

The cable arrangement of FIGS. 2A and B may be used directly to wind non-insulated HTS field coils, or it may be used together with additional layers between the cables (e.g. partially insulating layers as disclosed in WO/2019/150123 A1) to a partially insulated HTS field coil with controlled resistance between the turns. However, such partially insulating layers can be relatively bulky, and in combination with the relatively thick channel may result in a lower than desired current density.

As such, constructions are proposed herein to provide an HTS cable having integrated elements such that when it is wound it would provide a partially insulated coil with resistance that can be easily controlled by the design of such elements. Additionally, similar designs allow for the integration of any desired circuitry or components with the HTS cable.

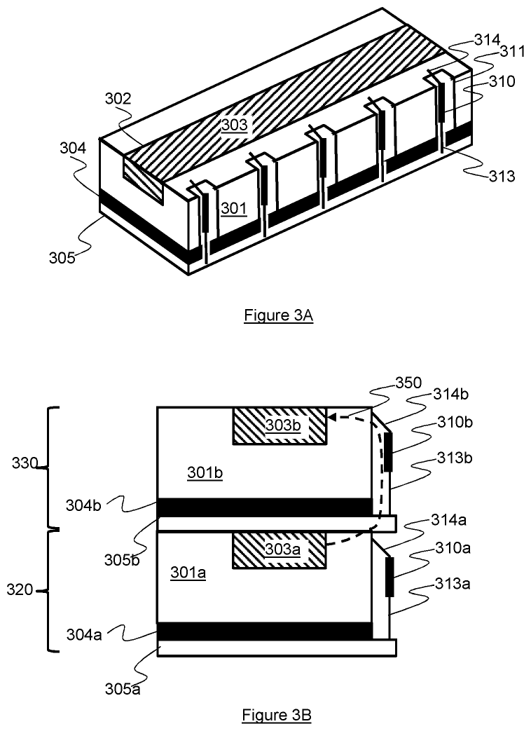

FIG. 3A shows an HTS cable having integrated resistors to connect turns of the resulting HTS coil when the HTS cable is wound. The HTS cable comprises a conductive channel 301, having a groove 302 along its length. HTS material 303 is located within the groove as described above. The HTS cable further comprises an insulating layer 304 on a lower face of the channel (i.e. such that it would be between the HTS cable and another turn of the HTS cable when the HTS cable is wound into a coil), and a conductive layer 305 on a lower face of the insulating layer. The insulating layer covers the lower face of the channel, except as specified otherwise. The conductive layer may cover all of the insulating layer, or only a portion thereof.

The HTS cable further comprises a plurality of resistors 310 which are located in recesses 311 in the side of the HTS cable. Each resistor 310 is electrically insulated from the HTS cable by insulation within the recess, and has a first connection 313 which extends through the insulating layer 304 to electrically connect to the conductive layer 305, and a second connection 314 which electrically connects to the conductive channel 301.

FIG. 3B shows the radial current flow between a first turn 320 and a second turn 330 for a cross section which aligns with a recess in the HTS cable on each turn (though note that the recesses need not be aligned between turns). Reference numerals for individual components of the first and second turns are equivalent to those in FIG. 3A, but with the suffix “a” for components of the first turn and the suffix “b” for components of the second turn. When the HTS cable is wound to form an HTS coil, the cable of the first turn 320 lies under the cable of the second turn 330, such that the conductive layer 305b of the second turn is in electrical contact with the upper surface of the channel 301a of the first turn, electrical connection between the turns (indicated by dotted arrow 350 for current flowing from the first turn to the second) happens radially via the resistors 310b of the second turn, i.e.:
from the HTS material 303a of the first turn
through the channel 301a of the first turn
through the conductive layer 305b of the second turn
through the resistor 310b of the second turn via the connection 313b;
through the channel 301b of the second turn via the connection 314b;
to the HTS material 303b of the second turn.

It should be noted that while FIG. 3B shows only two turns, an HTS coil may comprise any number of turns. Furthermore, as the HTS coil may be wound from a single HTS cable, the channels 301a and 301b may be different sections of a single channel 301, and similarly for the insulating layer 304a/b, conductive layer 305a/b, and HTS material 303a/b

This allows the resistance of the connection between the turns to be easily adjusted when designing the cable, by choosing the resistance of the resistors accordingly. There will be some additional contribution to the resistance from the conductive material of the channel and bonding agents, and from non-superconducting components e.g. of HTS tapes, but these can be easily determined by calculation or experiment and factored in to the designs.

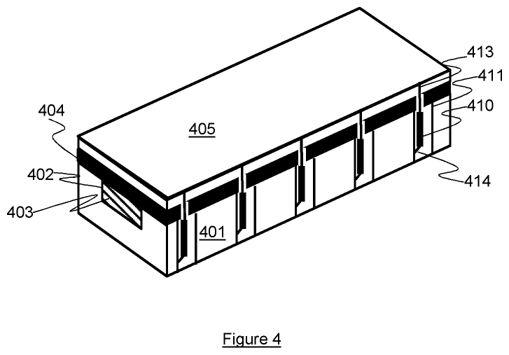

As an alternative shown in FIG. 4, the insulating layer 404 may be provided on an upper surface of the channel 401, i.e. covering the groove 402 which contains the HTS material 403. The conductive layer 405 is then provided on an upper surface of the insulating layer 404, and the resistors 410 have one connection 413 which extends up through the insulating layer, and another connection 414 which connects to the channel. It will be appreciated that this alternative arrangement of the insulating layer and conductive layer is possible for all examples presented in this disclosure, even if not shown specifically for those examples.

Additionally, the conductive layer 305/405 may be omitted, and the electrical connections 313/413 which extend through the insulating layer may terminate at the surface of the insulating layer, for connection to components to be placed on the other side of the insulating layer. Further, rather than extending through the insulating layer, the connections 313/413 may extend around or otherwise across the insulating layer.

While the above examples have shown a simple example using resistors integrated into the channel, the same principle can be applied to any electrical components. FIG. 5 shows a generic embodiment of this principle. The HTS cable comprises a channel 501, a groove 502, HTS material 503, an insulating layer 504, and a conductive layer 505 as in the previous examples. The HTS cable further comprises a plurality of assemblies of electronic components 510, which are located in recesses 511 in the side of the channel 501, and insulated from the channel 501 by insulation (not shown) except as noted below.

Similarly to the case shown in FIG. 3B for the resistors 310, current flowing radially between turns of an HTS coil wound from the HTS cables of FIG. 5 will flow via the assemblies of electronic components 510.

The assemblies have one or more electrical connections 513 through the insulating layer 504 to the conductive layer 505. The assemblies also have one or more electrical connections 514 to the channel 501 and/or HTS material 503, where current flowing from the electrical connections 513 passes through at least one component of the assembly 510 before flowing through the electrical connection 514, or vice versa. The assembly may contain passive devices, such as diodes or varistors, which react to a change in local conditions in the coil pack, such as voltage between turns, temperature or pressure, for example. This allows the components to change their electrical resistance in response to a fault condition that could lead to a quench. Alternatively the assembly may comprise active components such as semiconductors (field effect transistors) switches, etc which are controlled by an external voltage; in this case it may comprises a further electrical connection or connections 515 for receiving inputs for these components. Where the assembly comprises active components actuated by other means (e.g. hydraulic or pressure activated switches), it may comprise appropriate inputs for those means of activation. Pressure switches and similar devices have the advantage over diodes or active semiconductor switches of not having a forward voltage. Pressure switches may be operated externally by a change in gas pressure or, by sealing off the pressure chamber inside the switch, gas pressure can be generated internally due to temperature changes.

Components with variable resistance allow the coil to be operated with high or low turn-turn resistance. This is advantageous to allow the coil to be energized quickly (the components would have high resistance to minimise current being driven between turns by the inductive voltage developed across them by changing current) and then switch to a low turn-turn resistance state to make the coil stable against disturbances when the in-turn current is stable.

It may also be advantageous to adjust the turn-turn resistance in real time. For example, when rapidly dumping energy from the magnet following detection of a quench or conditions likely to cause a quench, a higher resistance between turns could drive a larger fraction of decaying current to an external dump resistance, reducing the amount of magnet energy dumped into the coil pack and hence reducing the terminal coil temperature, thus avoiding transient stresses caused by rapid thermal expansion of different parts of the coil structure.

The assembly 510 may comprise any desired components to achieve the required electrical interactions radially between turns of the HTS coil when the HTS cable is wound. For example, the assembly may comprise resistors, diodes, varistors, thermistors and other temperature dependent resistors such as cartridges containing vanadium oxide or other compounds, transistors (e.g. MOSFETS), thyristors, capacitors, switches (e.g. hydraulic or pressure activated switches), superconducting elements (e.g. superconducting elements having greater sensitivity to temperature changes than the HTS material), circuits or integrated circuits containing combinations of the above components, etc. One possible circuit or integrated circuit is an RC-filter connected to the gate voltage of a switch (e.g., a transistor or thyristor) to enable the triggering of a change from a high resistance state to a low resistance state. Other circuit designs are of course possible. As a further example, each electrical assembly may comprise a conductive path, e.g. a conductive path whose material, cross section, and length are chosen to provide a required resistance, such that it acts as a resistor. A current path with a greater length than any dimension of the recess may be achieved by providing a current path which is not straight.

A plurality of assemblies are placed along the HTS cable, in respective recesses. These assemblies may be electrically connected to each other, e.g. to allow coordinated control of switching within the assemblies. The spacing of these assemblies is determined by the required bulk electrical properties of the HTS cable, i.e. for resistive assemblies a greater spacing between the recesses will result in a greater average resistance per unit length for the HTS cable as a whole. The spacing of the recesses may vary along the HTS cable, e.g. such that when wound the cable provides an HTS coil having variable turn-to-turn resistance along different arcs of the coil. The assemblies may vary in their construction or electrical properties, e.g. having different resistances in different assemblies, or alternating between several kinds of assembly in a repeating pattern.

The assemblies will be required to fit within the material of the channel either side of the groove without structurally compromising it, but the width of the material of the channel either side of the groove will generally be between 3 and 15 mm, and the height of the channel material will generally be between 3 and 25 mm, which allows plenty of space for electrical components given the miniaturisation of such components.

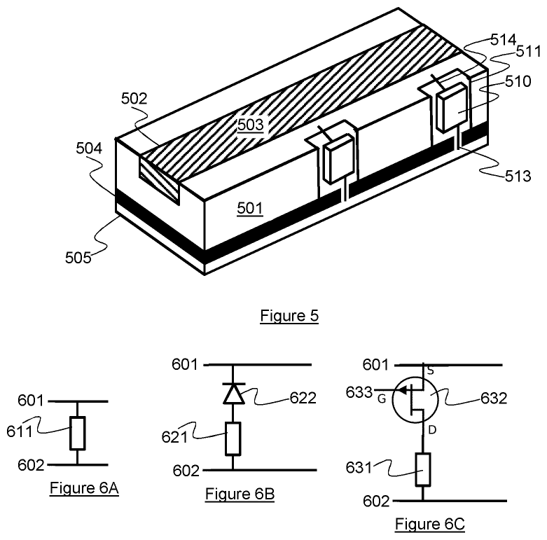

Some exemplary assemblies are shown as circuit diagrams in FIGS. 6A to 6C. In each case the upper rail 601 represents the connection to the channel, and the lower rail 602 represents the connection through the insulating layer.

FIG. 6A represents the example shown in FIG. 3A, where the electrical component within the recess is a resistor 611. This provides a fixed resistance per recess, and the turn-to-turn resistance per unit length of the HTS cable when wound into an HTS coil can be controlled by varying the resistance of the resistor 611 or the spacing of the recesses.

FIG. 6B shows an example having a resistor 631 and a diode 632 connected in series in the recess, which could also be implemented without the resistor if the resistance of the diode and the electrical connections to it would be sufficient. The diode limits current flow through the resistor to only a single direction below its forward voltage. This voltage can be increased by putting multiple diodes in series. Pairs of back to back diodes extend the idea to allow current flow in either direction. As an extension of this principle, two sets of such assemblies could be provided where the first set allows current to flow radially outwards through the coil and the second set allows current to flow radially inwards, allowing independent control of the resistance in each direction.

FIG. 6C shows an example having a resistor 631 and a MOSFET transistor 632 connected in series, with the gate of the MOSFET connected to a control input 633. The control input may be connected to an external controller, which allows radial current flow in the HTS coil wound from the HTS cable to be controlled electronically, for example to allow the HTS coil to act similar to an insulated coil when ramping (resulting in a reduced ramping time), but as a partially insulated coil when operating (resulting in increased resistance to quenching).

In general where the assembly of electronic components includes active components such as transistors or other components whose state changes due to an applied voltage, a control input may be included. This control input may connect to an external controller, or may connect to electronic components in other recesses to allow propagation of control inputs along the HTS cable.

When the example HTS cables above are wound into a coil, the conductive layer 305/405/505 (or the electrical connections 313/413/513 if the conductive layer is not present) is brought into contact with the opposite surface of the channel 301/401/501. As such, current can flow radially between turns of the resulting HTS coil via the electrical components 310/410/510 within the recesses in the channel.

The insulating layer between turns can also be configured as a flexible printed circuit board containing a sense wire to act as a sense wire for obtaining the non-inductive component of the voltage across all turns. This is done by subtracting the inductive voltage developed across the open circuit sense with, when current in the coil is changing, from the start-end voltage across the coil (which is the vector sum of the inductive and non-inductive components).

While the figures only show recesses on one side of the cable, it should be appreciated that this is for illustrative purposes only and recesses may be disposed on both sides of the cable. Additionally, where the description refers to “upper” or “lower” surfaces, or implies any particular orientation, it should be appreciated that this is for ease of understanding in the description and that the HTS cable may be provided in any orientation (and indeed, will generally be wound into a coil such that absolute orientations are not particularly meaningful in practice). Similarly, while the figures show recesses with straight sides extending the full height of the channel, it will be appreciated that the recesses may be of any size which fits the required electrical components within them, and may extend only partly up the height of the channel, provided that limitations around electrical connection to and insulation from the channel are met. In general the figures should be taken as schematic illustrations designed to emphasise particular concepts, rather than faithful representations of actual physical apparatus. While some cross hatching and block filling has been used in the drawings to distinguish particular materials (i.e. HTS material and insulator), the presence or absence of cross hatching and block filling for certain elements does not imply that they are formed of the same material as other elements with the same presence or absence of cross hatching or block filling unless otherwise stated. In particular, the channel and the conductive layer(s) may be formed from different conductive materials.

FIG. 7 shows a cross section of an alternative construction for an HTS cable. As with the previous examples, the HTS cable comprises a channel 701, a groove 702, and HTS material 703 within the groove. The HTS cable further comprises an insulating layer 704 which covers the bottom and sides of the channel, and a conductive layer 705 (e.g. copper or stainless steel, or elements of both) which covers the insulating layer 704 and extends to the top of the channel 701.

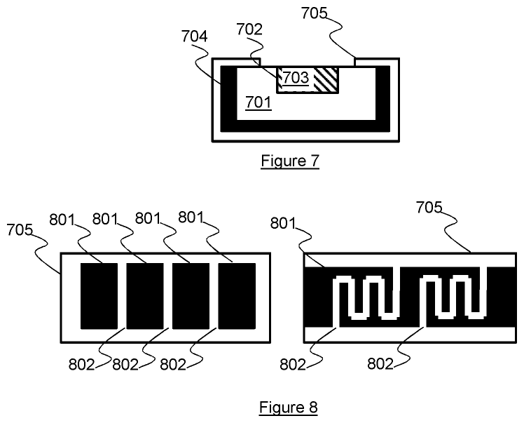

When wound, this design allows current to flow between turns via the conducting layer 705, with a resistance dependent on the thickness and material of that layer. FIG. 8 is a side view of an example construction according to FIG. 7. To further control the resistance, the conductive layer 705 may have cutouts 801 on its side faces to produce a set of current paths 802 which will have a greater resistance than would be provided by a complete conductive layer. These cutouts may restrict the width of the conductive paths as shown in the left side of the figure, or they may define more complex conductive paths as shown on the right side, allowing a greater length of conductive path (and hence resistance) than would be possible with straight conductive paths.

Within this disclosure “insulator” takes its normal definition, i.e. a material through which electrical current does not flow freely, and which has a greater resistivity than conductors or semiconductors, e.g. greater than 10⁵ Ohm/meter or 10¹⁰ Ohm/meter. Conductive materials include metals, metal alloys, and carbon (in amorphous or graphite form). The turn-to-turn voltage within an HTS coil is generally sufficiently low that breakdown voltage does not need to be considered as a factor

1. A high temperature superconducting, HTS, cable comprising:
a channel formed from conductive material, the channel having a groove extending along the length of the HTS cable;
HTS material located within the groove, such that when the HTS material is in a superconducting state the HTS material forms a superconducting current path along the cable, and the HTS material is electrically connected to the channel;
an insulating layer located on surfaces of the channel other than a surface where the groove is present;
a conducting layer located on an outer surface of the insulating layer, and extending around the insulating layer to make electrical contact with the channel.

2. An HTS cable according to claim 1, wherein the conducting layer has a plurality of cutouts and a plurality of current paths between the cutouts, each current path connecting the surface of the channel where the groove is present to the opposite surface of the conducting layer.

3. A high temperature superconducting, HTS, cable comprising:
a channel formed from conductive material, the channel having a groove extending along the length of the HTS cable;
HTS material located within the groove, such that when the HTS material is in a superconducting state the HTS material forms a superconducting current path along the cable, and the HTS material is electrically connected to the channel;
an insulating layer located on a surface of the channel;
the channel having a plurality of recesses, each recess containing a electrical assembly comprising a conductive path and/or one or more electrical components, each recess further containing insulation which separates the electrical assembly from the channel;
the HTS cable further comprising, for each recess:
a first electrical connection which provides an electrical connection across or through the insulating layer from the electrical assembly within the recess;
a second electrical connection which electrically connects the channel to the electrical assembly within the recess;
such that any conductive path from the first electrical connection to the second electrical connection through the recess passes through the electrical assembly.

4. An HTS cable according to claim 3, and comprising a conductive layer located on a surface of the insulating layer opposite the channel, the conductive layer comprising one or more conductive elements in electrical contact with the first electrical connections.

5. An HTS cable according to claim 3, wherein the one or more electrical components comprise any one or more of:
a resistor;
a transistor;
a thyristor;
a switch;
a pressure or hydraulic activated switch;
an integrated circuit;
a capacitor;
a diode; and
a varistor.

6. An HTS cable according to claim 3, wherein the channel is formed from copper, stainless steel or a combination thereof.

7. An HTS cable according to claim 3, wherein the recesses are evenly spaced along the length of the channel.

8. An HTS cable according to claim 3, wherein the spacing between adjacent recesses varies along the length of the channel.

9. An HTS cable according to claim 3, wherein each recess contains an electrically equivalent arrangement of the one or more electrical components.

10. An HTS cable according to claim 3, wherein the plurality of recesses comprises a plurality of sets of recesses, and wherein within each set of recesses each recess of that set contains an electrically equivalent arrangement of the one or more electrical components.

11. An HTS cable according to claim 10, wherein the recesses form a pattern such that the arrangement of recesses of each set repeats periodically along the channel.

12. An HTS cable according to claim 3, wherein each electrical assembly comprises one or more active components.

13. An HTS cable according to claim 12, and comprising a control input for each recess, wherein voltage applied to the control input causes a change of state in at least one active component within that recess.

14. An HTS cable according to claim 13, wherein the control input for each recess connects to the electrical assembly of another recess via a conductive path which is electrically isolated from the channel.

15. A high temperature superconducting, HTS, coil comprising HTS cable wound to form the turns of the coil, wherein the HTS cable is an HTS cable according to claim 1.

16. A high temperature superconducting, HTS, coil comprising HTS cable wound to form the turns of the coil, wherein the HTS cable is an HTS cable according to claim 3.

17. A high temperature superconducting, HTS, coil comprising HTS cable wound to form the turns of the coil, the HTS cable comprising:
a channel formed from conductive material, the channel having a groove extending along the length of the HTS cable;
HTS material located within the groove, such that when the HTS material is in a superconducting state the HTS material forms a superconducting current path along the cable, and the HTS material is electrically connected to the channel;
an insulating layer located on a surface of the channel;
the channel having a plurality of recesses, each recess containing a electrical assembly comprising a conductive path and/or one or more electrical components, each recess further containing insulation which separates the electrical assembly from the channel;
the HTS cable further comprising, for each recess:
a first electrical connection which provides an electrical connection across or through the insulating layer from the electrical assembly within the recess;
a second electrical connection which electrically connects the channel to the electrical assembly within the recess;
wherein the HTS cable is wound such that the first electrical connections of each turn other than the innermost or outermost turn electrically connects to the channel of an adjacent turn, such that any current path from each turn to the adjacent turn via each recess pass through the electrical assembly within that recess.

18. A high temperature superconducting, HTS, coil comprising HTS cable wound to form the turns of the coil, wherein the HTS cable is an HTS cable according to claim 2.
